(19) United States
(12) Patent Application Publication
(10) Pub. No.: US 2002/0007348 A1
(43) Pub. Date: Jan. 17, 2002

(54) System and method for performing engineering design

(76) Inventors: Mohamed Ahmed Ali, Niskayuna, NY (US); Bharat Sampathkumaran Bagepalli, Niskayuna, NY (US); Michael Joseph Krok, Clifton Park, NY (US); Jeffrey LeMonds, Clifton Park, NY (US); Andrew Joseph Poslinski, Schenectady, NY (US); Mark Alan Preston, Niskayuna, NY (US); Brion Daryl Sarachan, Schenectady, NY (US); Gerald Gene Trantina, Eastham, MA (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/772,060

(22) Filed: Jan. 29, 2001

Related U.S. Application Data
(60) Provisional application No. 60/178,600, filed on Jan. 28, 2000.

(51) Int. Cl. G06F 17/60

(52) U.S. Cl. 705/51

(57) ABSTRACT

An exemplary embodiment is a system and method for performing engineering design. The system includes a client for receiving first design information from a first source. The system also includes a server coupled to the client via a network. The client uploads the first design information to the server, and the server determines whether the first source has authorization to submit the first design information, notifies a second source of the first design information and transmits the first design information to the second source. The server stores the design information.

### CROSS-REFERENCE TO RELATED APPLICATIONS

This application claims the benefit of U.S. provisional patent application Ser. No. 60/178,600 filed Jan. 28, 2000, the entire contents of which are incorporated herein by reference.

### BACKGROUND

The invention relates generally to engineering design processes, and more specifically, to a system and method for performing engineering design.

Design, engineering and manufacturing of highly technological products is becoming increasingly complex. The complexity arises due to several factors. The first factor is the “single product—diverse technology” factor. In other words, customer demand and manufacturer competition calls for loading products with numerous features and capabilities, some utilizing heterogeneous disciplines of science and technology. For example, modem “simple” products, such as telephone sets, have control systems, embedded software, and digital signal processing capabilities. In addition, fracture mechanics studies are typically performed on products to assess the likelihood of mechanical damage. Thus, such a “simple” product may utilize mechanical, electrical, and software engineering designs that no single engineer (and in some cases no single engineering organization) can fully grasp independently.

The second factor creating the complexity is that technology, in and of itself, is becoming ever increasingly complex. Not only are products becoming an amalgamation of diverse and heterogeneous technologies (as described above), but each technology is becoming more complex due to the number of scientists and engineers designing the state-of-the-art or state-of-the-science products. Both these factors, combined, are generally referred to as increased product complexity (complexity that results both from the increased number of technologies involved, and the increased complexity of any given technology). A third factor is called comparative advantage. In other words, pricing pressure in the market place, coupled with the diversity of technology as described above, has led companies to attempt to devise a simple scheme meet the challenges. Such a typical scheme includes dividing the product into its components and then doing the design work. Many times, component manufacturing performed remotely from the facility or facilities creating the design. Note that manufacturing location is primarily driven by quality and economics. However, regions of the world with the highest comparative advantage, in one or more of the technologies comprising modem products, certainly have better chances at being selected as a manufacturing site. Thus, a global economy has emerged, due in part, to the prospect that no single region, organization, or location could possibly have a comparative advantage in all technologies involved in engineering, designing and manufacturing any given product.

Due to the global economy's unprecedented growth, along with the complexities of engineering, designing and manufacturing products, communication among participating entities is key. Many potential regions of the world are not considered as viable engineering and manufacturing sources due to such complexities. Therefore, communication among the different participating locations/sub-organizations is essential to ensure that all involved technologies will work in tandem, and meet the desired design requirements. However, increasing the number of locations/sub-organizations results in fragmentation of the product knowledge, engineering, and manufacturing. Thus, communication between these fragmented, global locations/sub-organizations can become massive, cost prohibitive and impossible to manage. Failure to realize globalization to its fullest due to the communication barrier can lead to several problems. The first problem may be lost design cycle time. In other words, Engineers may spend too much time trying to get access to data from other sub-organizations. A second problem may be lost opportunity to satisfy the customer. In other words, if design engineers do not have a direct line of communication with the customer, they may receive misleading information regarding customer needs and requirements. Another problem may be inconsistent product quality. In other words, locations/sub-organizations might not share quality control data and ideas. Thus, even if each location/sub-organization has a repository for depositing quality data and learning from previous successes and failures, the overall amalgamation of all the data may never occur. Such lost opportunities can force a company to operate at costly, sub-optimal levels having an impact the company's profits and, consequently, on the global economy.

As is known, the Internet is a means of communication in which data can be exchanged between computers. As discussed, engineering organizations exchange design information across the organization via e-mail, Web sites, phone calls and/or word of mouth, and the like. Due to the variety of ways the design information is exchanged, the design information exchange takes place in a fragmented manner, without any organized structure for storing and relaying the design information. As an example of design information exchange, spreadsheet files are typically utilized to provide functional relationships (transfer functions) between design parameters (x's) and critical to quality (CTQ) parameters (y's). While exchanging a spreadsheet file between engineers, the sender will have to describe to the recipient where to find the x's and y's in the spreadsheet before the spreadsheet is usable. These transfer functions relating y's to x's are typically important components of the whole design and need to be archived for future usage and referral. However, archiving or retrieving the randomly formatted spreadsheets is unworkable. Note that CTQ parameters are utilized in a quality tool such as Six Sigma quality analysis programs as described below. Decisions made regarding direction, interpretation, scope, depth or any other aspect of quality effort are typically be based on actual data gathered, and not opinion, authority or guesswork. Key CTQ characteristics are set by customers. Based on the CTQs, internal measurements and specifications are developed in order to quantify quality performance. Quality improvement programs are developed whenever there is a gap between the customer CTQs and the current performance level.

With the advent of the Internet and worldwide marketplace as well as the corresponding consumer demand for highly reliable products, quality always remains an increasingly important issue. The quality of a company's product line can therefore play a decisive role in determining the company's reputation. As a result of this pressure for defect-free products, increased emphasis is being placed on quality control at all levels; it is no longer just an issue with which quality control managers are concerned. This has led to various initiatives designed to improve quality, such as the Total Quality Management (TQM) and the Six Sigma quality analysis programs.

In business, the Internet, e-mails and Web pages are becoming the preferred modes of communication amongst employees in a corporation. With the increase in the number of employees in a corporation using a server computer system to communicate with other employees (and to search for information from various electronic Web sites), an opportunity for potentially meaningful and productive work related interaction amongst employees arises.

Currently, Web pages are typically defined using Hypertext Markup Language (hereinafter referred to as “HTML”). HTML provides a standard set of tags that define how a Web page is to be displayed. When a user indicates to the browser to display a Web page, the browser sends a request to the server computer system to transfer to the client computer system an HTML document that defines the Web page. When the request HTML document is received by the client computer system, the browser displays the Web page as defined by the HTML document. The HTML document contains various tags that control the displaying of text, graphics, controls, and other features. The HTML document may contain Uniform Resource Locators (hereinafter referred to as “URL”) of other Web pages available on that server computer system or other server computer systems. Additionally, Web pages can also include applets. Applets are small computer programs written in JAVA programming language using an object-oriented programming (OOP) approach. When a user instructs the browser to download an applet, the browser sends an instruction to the server computer to transfer the applet to the user's computer, i.e., personal computer, laptop computer, network system, and the like.

As mentioned, Six Sigma is a data driven methodology to improve the quality of products and services delivered to customers. For any process (business, manufacturing, service, etc.), the sigma value is a metric that indicates how well the process is performing. The higher the sigma value, the better the output. Sigma measures the capability of the process to perform defect-free-work, where a defect is synonymous with customer dissatisfaction. With Six Sigma, the common measurement index is defects-per-unit where a unit can be virtually anything—a component, a part of a jet engine, an administrative procedure, etc. The sigma value indicates how often defects are likely to occur. As sigma increases, customer satisfaction goes up along with improvement of other metrics (e.g., cost and cycle time).

The design for Six Sigma (DFSS) process is a disciplined process for designing products and services in which massive sets of data are exchanged. The design process can be summarized as being a sequence of events. Whenever an event takes place, it is communicated to certain individuals and/or computers in the organization. This launches an activity, which launches another event upon completion of the activity. This new event restarts the cycle again with another activity until the entire process is completed. In other words, the DFSS process can be described as a sequence of an event-communication-activity-event cycle, which becomes the building blocks of the design process. The Six Sigma methodology has been used by a number of major companies, which use this process for a specific application (such as semiconductor manufacturing). Therefore, current engineering design processes that attempt to implement quality control programs, such as DFSS, may become counter productive due to the fragmented nature of the typical engineering design process. Additionally, such an implementation of a quality control program may become cost prohibitive and even ineffective.

Thus, communication and management among the different participating locations/sub-organizations can become a nightmare of a feat. Resolution of the “communications barrier” needs to be profound and immediate. Failure to properly communicate and manage multiple engineering and manufacturing locations/sub-organizations can result in inferior and expensive products, and can undermine the very essence of globalization.

Therefore, there remains a need for a system and method for performing engineering design that reduces the cost, time and errors in the engineering design process.

### SUMMARY

An exemplary embodiment is a system and method for performing engineering design. The system includes a client for receiving first design information from a first source. The system also includes a server coupled to the client via a network. The client uploads the first design information to the server, and the server determines whether the first source has authorization to submit the first design information, notifies a second source of the first design information and transmits the first design information to the second source. The server stores the design information.

### BRIEF DESCRIPTION OF THE DRAWINGS

Referring now to the drawings wherein like elements are numbered alike in several FIGURES:

FIG. 1 illustrates an example of a typical exchange of design information in an engineering organization;

FIG. 2 is a flow chart of a DFSS process;

FIG. 3 is a flow chart of an engineering design process;

FIG. 4 illustrates an example of an engineering design project;

FIG. 5 illustrates engineering design steps;

FIG. 6 is a flow chart of an exemplary embodiment of an engineering design process utilizing a network;

FIG. 7 illustrates an example of an engineering design project using an exemplary embodiment;

FIG. 8 illustrates a multi-layer object-oriented process design;

FIG. 9 illustrates an automated QFD process;

FIG. 10 illustrates an exemplary embodiment of a system for performing engineering design;

FIG. 11 illustrates an exemplary division of effort in designing a product (along the tool lines);

FIG. 12 illustrates an exemplary embodiment of exchange of design information in an engineering organization utilizing a central repository;

FIG. 13 illustrates an exemplary embodiment of a central repository;

FIG. 14 is an exemplary embodiment of an architecture for implementing the central repository; and

FIG. 15 is an exemplary embodiment using a network.

### DETAILED DESCRIPTION

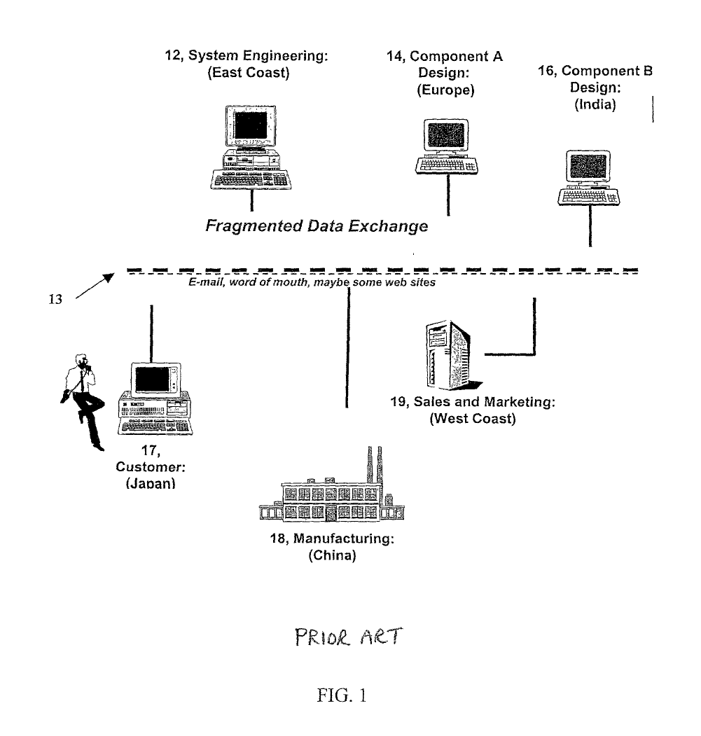

An engineering organization 10 exchanging status and design information is illustrated in FIG. 1. In FIG. 1, design information is being exchanged across the organization in an ad hoc and unstructured manner without real backbone that fully utilizes a network's (such as the Internet's) capabilities. Note that due to the variety of ways the design information is exchanged, the design information exchange takes place in a fragmented manner, without any organized structure for storing and relaying the design information. To ensure that designed/manufactured components designed at each location become a coherent product, each location needs data residing at, or maintained by other locations. For example, design engineers at two locations 14 and 16 not only need to communicate with each other, but may require production capability data from the manufacturing facility 18, customer data from the customer 17, data from sales & marketing 19 and system-level design and requirement data from system engineering 12. Communication between these entities is usually multi-directional, requiring several iterations ensure compatibility and resolve “design collisions” between different technologies. An example of a design collision occurs when several components compete for the same space in a product (e.g., same bandwidth, or similar constraints). Such a complex communications situation results in a massive communication web 13 that becomes increasingly complex as globalization increases, until it becomes cost and management prohibitive (a communication barrier). The situation can be further compounded by language and organizational structure barriers, thus, resulting in a further fragmentation of data exchange. Thus, second-hand data (indirectly obtained data) is common in large engineering organizations, potentially resulting in improper decision making and costly mistakes.

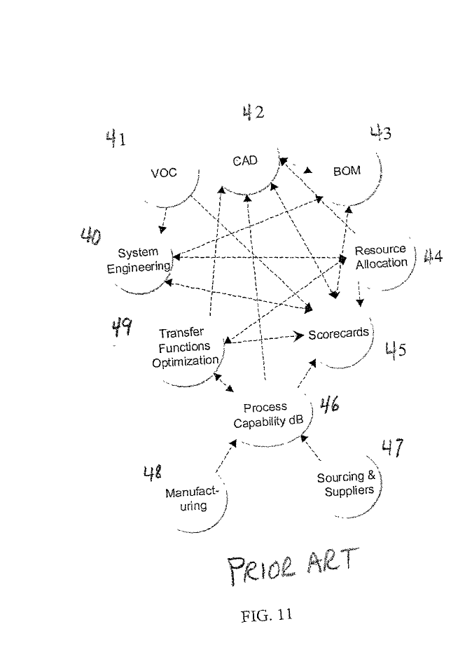

Often, engineering design organizations are not simply divided along product components, as previously discussed. Instead, the divisions are usually more subtle. In other words, the divisions may be made along both functional and “tool” lines. For example, a computer-aided-design (CAD) sub-organization may exist to serve sub-organizations engaged in the design of different product components. FIG. 11 illustrates an exemplary division of effort in designing a product (along the tool lines). Many of the tools described in FIG. 11 were not integrated in the past, thus, data communication between them was a manual process, and often labor intensive. For example, an engineer who optimized a certain component, would have manually updated the relevant performance scorecards. As shown, the division in an engineering organization can become even more vague, given the example of FIG. 11. Note that the tools shown in FIG. 11 are:

VOC 41: Voice of the Customer tools may be used to collect and document customer requirements. Survey and Quality Function Deployment (QFD) (a technique devised by the Japanese to collect customer requirements in a structured manner tools) are the primary examples.

CAD 42: CAD tools may be utilized to generate drawings of the product components and assemblies.

BOM 43: Bill of materials tools may be utilized to view and edit the product structure and the list of items involved in making up the entire product (for example, number of bolts, their sizes, number of flat sheets, their sizes and dimensions, etc.).

Resource Allocation 44: Resource allocation or project management tools may be utilized to balance work load with people and other resources to ensure timely delivery of the product within budgetary constraints.

Scorecards 45: Scorecards are management tools aimed at assessing the current status of the product while it is being designed or manufactured (in terms of meeting customer requirements with the necessary quality).

Process Capability dB 46: Process capability database is yet another tool for storing the capability of Sourcing and Suppliers 47 or Manufacturing 48 to meet engineering and quality requirements.

Transfer Functions Optimization 49: These tools may be used by engineers to estimate and optimize the product's (or a component thereof) performance to meet the intended goals. For example, engineers typically change fillet radii in mechanical components until optimal stress distribution and performance are obtained.

System Engineering 40: System engineering may be a tool (and method) used to ensure that the amalgamation of all components under design will meet the top-level customer requirements.

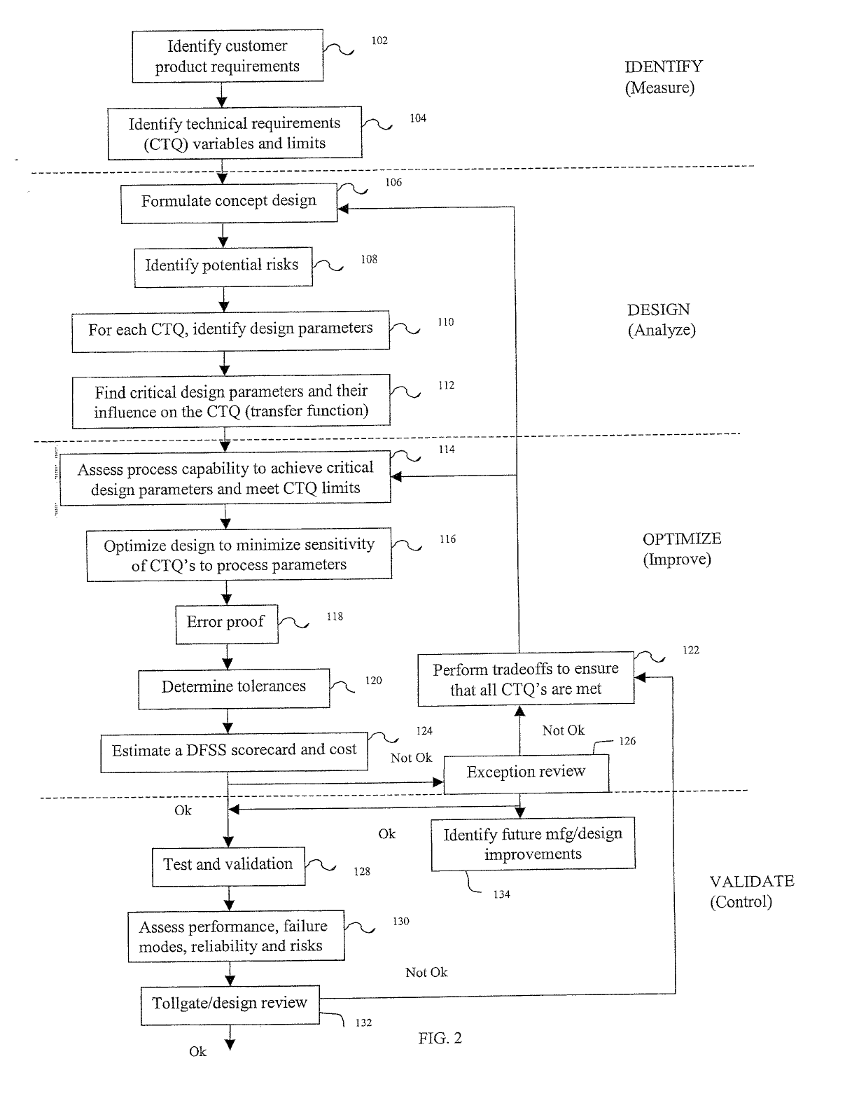

FIG. 2 is a flowchart of a DFSS process for an engineering design. Note that the overall process of FIG. 1 is divided into four sub-processes labeled “Identify,” “Design,” “Optimize” and “Validate.” Each sub-process includes sub-steps. The Identify sub-process includes sub-steps 102 and 104. The Design sub-process includes sub-steps 106, 108, 110 and 112. The Optimize sub-process includes sub-steps 114, 116, 118, 120, 122, 124 and 126. The Validate sub-process includes sub-steps 128, 130, 132 and 134. The DFSS process illustrated in FIG. 2 is useful for improving the process of designing a product or procedure. The process of FIG. 2 can also be applied to other Six Sigma processes such as the Measure, Analyze, Improve and Control (MAIC) process used for improving processes (such as manufacturing processes or business processes). Note that DFSS may be used with other Six Sigma or similar processes.

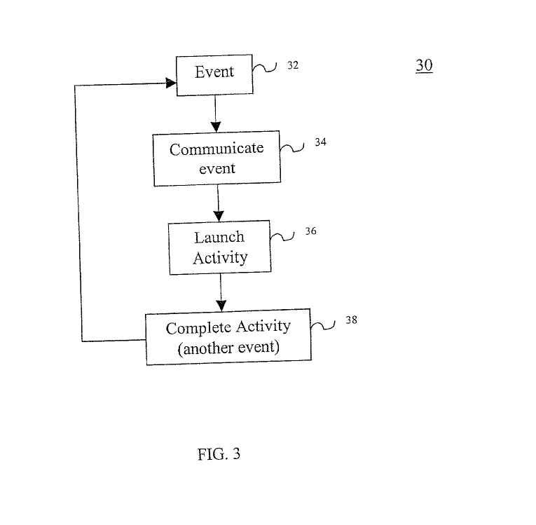

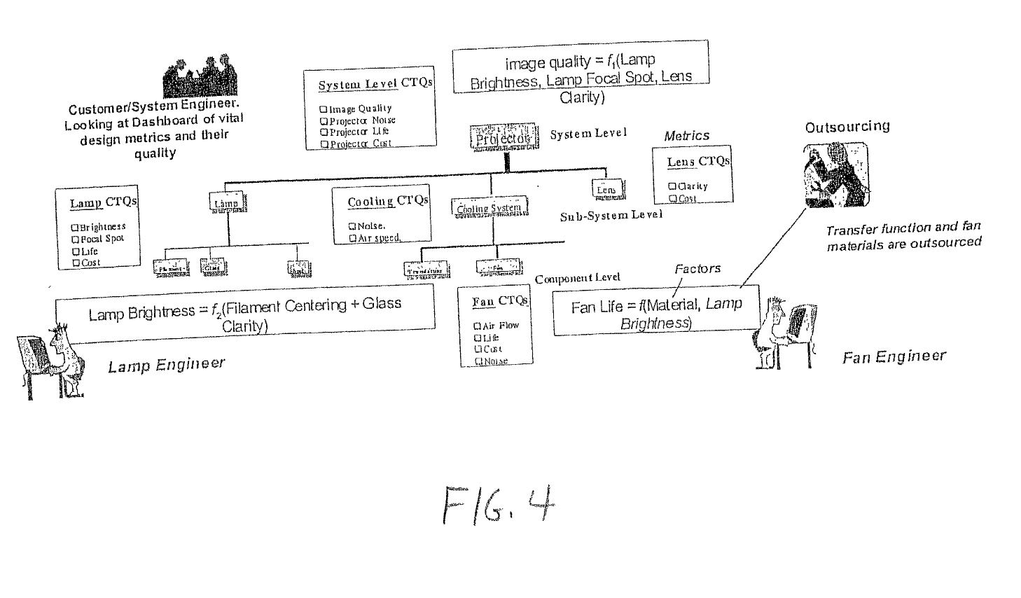

As discussed, in a typical engineering organization, design information (including events) are exchanged in an unstructured fashion. FIG. 3 is a flow chart of a typical design process 30 that begins with an event in step 32, which is communicated in some fashion in step 34. As result of the event communication, an activity is launched in step 36 with the activity completion being equal to a new event in step 38. Upon activity completion, the process is repeated. To illustrate the typical design information exchange across an engineering organization, an example of a projector design process is illustrated in FIG. 4. As shown, fan life is a factor of lamp brightness (determined by the lamp engineer). Therefore, designing the example projector requires collaboration between fan and lamp engineers. Moreover, in this projector example, fan materials and, therefore, the transfer function between fan life, materials and lamp brightness is out-sourced to another organization.

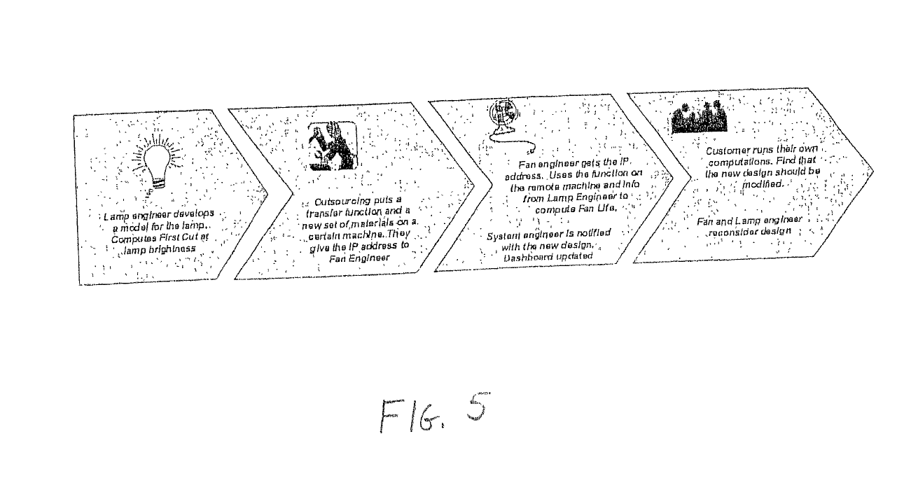

In FIG. 5, the flow chart of FIG. 3 is applied to the engineering design process illustrated in FIG. 4. The first event occurs when the design process starts. The activity occurs when the lamp engineer develops a lamp model. The end of this lamp model development activity is an event. The lamp engineer communicates that the first iteration at lamp design is accomplished (end of activity event) and that lamp brightness is now available. This can be communicated using e-mail, word of mouth or the like across the organization. Next, an outsourcing engineer develops the fan model (activity). Once the fan model is complete (activity completion event), the engineer posts the model on the Web and sends an e-mail, or the like to the fan engineer (communicating the occurrence of the event). The events in the example enable a fan engineer to start using lamp brightness (provided by the lamp engineer), fan model (provided by the outsourcing engineer), and fan materials (also provided by the outsourcing engineer) to design the fan (an activity is launched). Once the fan engineer's activity is complete (event), the projector design is complete (another event). The design completion event is communicated to the customer (for example over the phone). The process may need to be repeated if the new design does not meet customer satisfaction. Note that, typically, not all design information is communicated to the customer. Only the most important design parameters are usually communicated to the customer. Therefore, customer and management typically track a collection of the most important design metrics.

Therefore, design processes (and particularly the disciplined DFSS process) fit very well in the event-communication-activity-event cycle paradigm. However, the manner in which this cycle is currently performed has neither a structure nor strength. For example, each individual engineer currently selects a means of communication (e-mails, phone, word of mouth, etc.) that may be different one engineer to the next. Plus, each engineer selects the contents of what is communicated. As mentioned, in the projector example, the lamp engineer needs to know that the fan engineer will needs the lamp brightness design information. Thus, failure to recognize this can result in the lamp engineer sending more (or not enough) information than what the fan engineer needs. Too much information can be confusing and frustrating for the fan engineer. Typically, an engineering organization engaged in large design projects unnecessarily repeats the communicated design information. Thus, each engineer is expected to develop some knowledge about the requirements of other engineers in the organization. For example, the lamp engineer must be trained (or learn by mistake) to know that the fan engineer will need the value of lamp brightness. Otherwise, the lamp engineer may work with a design model that does not even produce lamp brightness as an output. Commonly, engineers new to a particular organization go through a time consuming process of learning how, when, where and with whom information should be exchanged. This learning process can be costly to a company, but just as importantly, the current process is cumbersome and ripe for error.

For example, currently, engineers have to know the names of the other engineers working on the project that may be affected by their designs (and visa versa). In the projector example, the lamp engineer must know that another engineer (the fan engineer) needs the parameters for lamp brightness, plus, the engineer must know the name of the fan engineer otherwise, information will either be overlooked or sent to the wrong individual. As discussed, in large design projects, this becomes a massive task, increases the learning time of engineers, creates confusion and the potential for error.

An exemplary embodiment is a method and system for performing engineering design. Design information on the system may be updated by the users (sources of design information) and become instantaneously available to all other users. The system may also be product-oriented. For example, the system may be modeled based on the product structure. Users may access, view, and/or download different pieces of the product that they are designing. Preferably, there is version control of stored data. Several versions of the same document can be stored. Security and user authentication is a preferred element in the communication system. For example, users may access limited domains of the system (which maps the actual product) with different permission levels (e.g., read-only or read and write).

Additionally, the system may have the other elements to facilitate design information exchange. The system may include a database to store all relevant designs performed in the past, e.g., as the organizational memory. Further, the database may be connected to a knowledge-based expert system. A database may also be provided for storing the product architecture including all revision of documents in the standardized formats. Further, the design process may be part of the implemented system. The design process can be controlled by a program, for example, that monitors data flow. A control program may also ensure that the steps of the overall design process are being followed by all involved parties.

The various elements for the system for engineering design are typically located on one or more servers. The functionality for the various system elements (all or some of the system elements) may be provided by one or more object-oriented product data management (PDM) software systems. PDM software systems may include multiple classes (e.g., object types) such as one or more subclasses and one or more super classes (e.g., a class from which another class, such as another super class or a subclass, inherits attributes and methods). Further, certain classes may be instanced and inherited. It is understood that various software systems, including commercially available systems, are suitable for use as at least a portion of a PDM software system, and it is also understood that certain software systems utilize different terminology. For example, e-Matrix®, which is a PDM product commercially available from MatrixOne, Inc., Chelmsford, Mass., the object types as are referred to as “types”, and Windchill®, which is a PDM product commercially available from PTC®, Waltham, Mass., the object types as are referred to as “documents”.

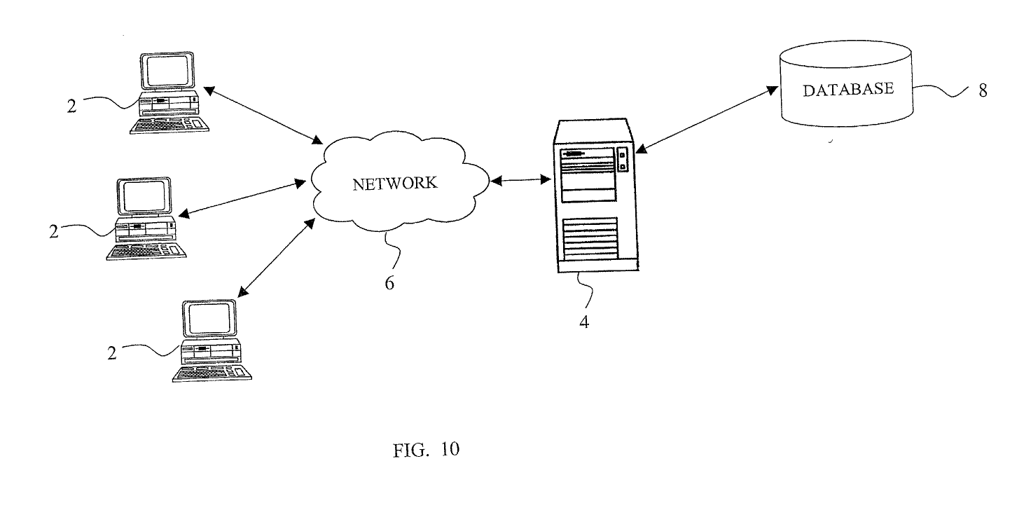

An exemplary embodiment of a system for performing engineering design is illustrated in FIG. 10. The system employs a client/server architecture and includes a network 6 (such as an Internet, intranet or the like) that is accessed by one or more sources (users). The users may download and/or upload design information through client side logic to a product data management (PDM) system over the network 6 in a standard format. The design information may be transferred in any standard transmission format and may be stored in a product data management format. The transmission format may also include standards for storage/retrieval of information. The design information may include data types such as CTQs, design parameters, transfer functions, product structure, constraints, dashboards or forms for combinations comprising at least one of the foregoing data types.

The system includes at least one server 4 and one or more clients, such as a computer(s) 2 or the like. Although only two computers 2 are shown for simplicity it should be appreciated that a plurality of computers can be located at different locations for use by a plurality of operators. Moreover, the server 4 can be identical to the computers 2 and is distinguishable as an embodiment only in that the server 4 may be the primary data storage source with which data stored in the computers 2 can be synchronized therewith.

As mentioned, the computers 2 may be coupled to the server 4 by the network 6, such as the Internet, a wide area network (WAN), local area network (LAN), Ethernet, intranet, a direct cable connection, a connection via phone lines and modems, or the like. Further, the network 6 may be continuous or intermittent and may be any mechanism for providing the communications described below. For example, the network 6 may include removable media, such as a diskette. As mentioned, design information may be sent over the network 6 in any appropriate format, such as, e-mail in simple mail transfer protocol (SMTP), as attachments to email, as ASCII or binary files using file transfer protocol (FTP), or the like. In an embodiment using the Internet, the computers 2 may execute a user application (e.g., web browser) for interacting with the server 4. Communication with computer(s) 2 can be achieved in any manner consistent with Internet information transfer, including but not limited to, HTTP and FTP, or a client/server connection. As previously discussed, Web pages are typically defined using HTML. HTML, however, provides only limited exchange of text and graphics and does not address exchange of CTQ's and transfer functions in an engineering organization. Therefore, an embodiment may use extended markup language (XML). XML was invented to generalize HTML. XML is similar to HTML, however, instead of pre-specified tags (as in HTML) tailored to text and graphics, the tags can be virtually anything.

System components may be located remotely from each other and coupled via the network 6. For example, the server 4 may be located separately from the computers 2, which may be located remotely from each other. As mentioned, the server may communicate with corresponding components via networks such as the Internet, WAN, LAN, Ethernet, intranet, a direct cable connection, a connection via phone lines and modems, or the like. Such remote locating is advantageous for widely dispersed engineering organizations. Similarly, a database 8 for storing server data may be coupled to the server 4.

In general, an embodiment of a method for engineering design is a network-based implementation for an engineering design process including inputting a plurality of design events on one or more computers and checking the authority of each inputter to submit the design events. (Note that different types of events were previously discussed herein.) If such authority exists the design event becomes one or more events for submission to an Internet-based database. The design events may be stored the Internet-based database. All persons affected by the design events are notified, such as when the person logs onto the Internet address. Additionally, information about the activities of individual persons with certain tasks (with along with related help files) may be provided. The process continues for each task in the design process until the design is fully completed.

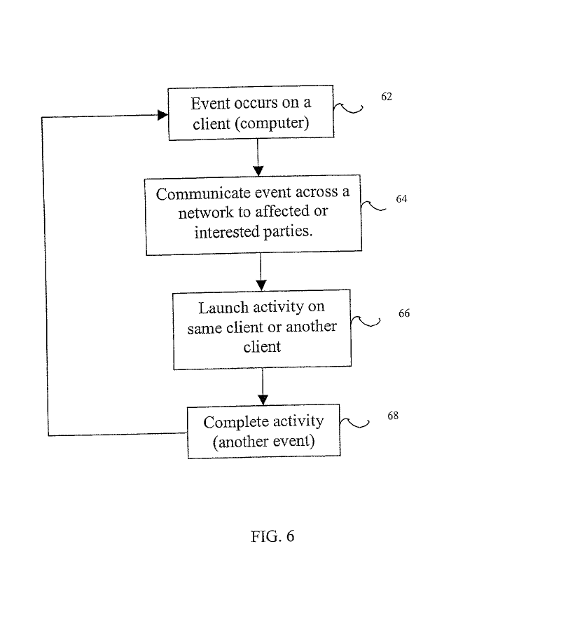

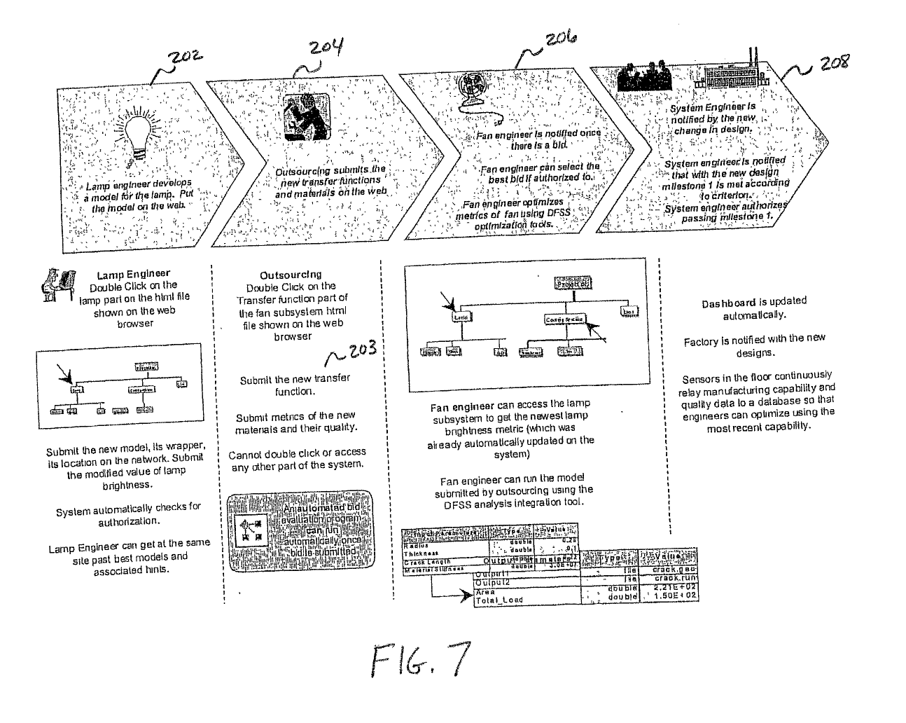

As mentioned, a network, such as the Internet or the like provides a vehicle for implementing an embodiment by eliminating the disadvantages previously discussed. In such an embodiment, the cycle shown in the flow chart of FIG. 3 becomes less costly and more reliable. FIG. 6 is a flow chart of an exemplary embodiment of a design process utilizing a network, and FIG. 7 illustrates an example of an engineering design project using the design process of FIG. 6. In step 62, an event occurs on a client (such as a computer). Next, in step 64, the event is communicated automatically across a network to the affected or interested parties. In step 66, an activity is launched on the same or another computer. In step 68, completion of the activity creates a new event, and the process is repeated. Once an activity is performed, an engineer submits the results of the activity to a Web-based program. The program checks if the engineer has the authority to submit the specific results. Once verified, the submission becomes an event (activity completion). All newly submitted information may be stored in a database. Next, all engineers affected by the event are notified, and when the engineers log into the Web-based program, they find only the information they require for their engineering design task. They may also find helpful information concerning the activities they are tasked with, along with related information that includes similar activities previously performed. As mentioned, once an activity is completed, it is submitted to the Web-based program (which is an event that triggers another activity), until the design process is complete. Thus, the design engineers' tasks become easier to manage, consume less time, produce fewer errors, and the engineering organiztion's operating costs are reduced.

In the embodiment for the example illustrated in FIG. 7, the lamp engineer develops a model for the lamp at 202. Next, the lamp engineer inputs the model on a network utilizing a Web-based program. For example, the lamp engineer may “double click” on the lamp part on an HTML file being shown on the Web browser. Thus, the lamp engineer submits a new model, its wrapper and location to the network. Next, the lamp engineer submits the modified value of lamp brightness. Next, the authority of the lamp engineer, to submit the design modification, is verified. The lamp engineer may also obtain past design models and associated hints.

An authorized individual from an outsourcing group submits the new transfer functions and materials (along with a bid) on the Web at 204. For example, this may be done by the outsourcing individual “double clicking” on the transfer function of the fan subsystem HTML file shown on the Web browser. At 203, the outsourcing individual submits the new transfer function. The outsourcing individual may also submit metrics of the new materials and their quality. Notwithstanding certain circumstances, the outsourcing individual may not be given access to any other part of the system.

At 206, a fan engineer is notified of the event (outsourcing bid, along with transfer function and material data). Thus, the Fan Engineer may select the best bid, if authorized. Next, the fan engineer may optimize the metrics of the fan using a quality program, such as DFSS optimization tools. To do so, the fan engineer gains access to the lamp subsystem and obtains the newest lamp brightness metric. Next, the fan engineer may run the model submitted by the outsourcing group using the DFSS optimization tool.

At 208, a system engineer having the overall responsibility for the design is notified by the new design change. Further, the system engineer is notified that a new design milestone has been met according to criterion. With this information, the system engineer authorizes the design to pass to the next milestone. The design dashboard (planning chart) is updated, and the factory may be notified of the new design. A sensor on the factory floor may be used to continuously relay manufacturing capability so that engineers can optimize the quality of the design with the most recent manufacturing capability.

An embodiment that replaces the complex communications web illustrated in FIGS. 1 and 11 may include a central repository and a “knowledge warehouse” (backbone). The central repository may be a company-wide repository that is accessible via the network (such as the Internet), and for each ongoing project in the company, the repository stores data, processes, tools, and allocated resources. Note that a company may broken down into four basic components:

1 Projects' Data: All the relevant product data such as dimensions, performance, quality, and the like.

2 Processes: The steps involved in designing and manufacturing the product being designed.

3 Tools: Software and/or hardware utilized by engineers and technologists to perform any of the steps comprising the processes.

4 Resources: Both human and otherwise. For example, who (human) and what (hardware or software) is working where (location) and on which project (allocation).

By effectively storing data from the four basic components of a company in a central repository and providing secure access to them, the entire design organization (no matter how its individuals are scattered across the world) may effectively work together. Engineers may have access to data they want. It may be available at all times in the central repository. Access may be provided without knowing which location/sub-organization owns or maintains the particular data set. Further, engineers may have access to what to do next. In other words, a company's best processes included and automatically enforced. Engineers may have access to all available resources in a continuous, real-time implementation. Engineers may have access to the best available tools. The tools may be coupled to the central repository. Engineers and technologists may gain access to the appropriate tool for a particular process step. For example, the engineer may receives an e-mail describing what to do next, along with the most appropriate tool available in the company for performing the task. Further, the “knowledge warehouse” may be added to the central repository. Thus, while the central repository maintains information on all ongoing projects, the knowledge warehouse may store only those with best results, and make them readily available for engineers to copy via the network. The knowledge warehouse may include identifying ongoing projects (or a part thereof) as being a “best practice.” The knowledge warehouse may be continuously updated and refined in the same manner.

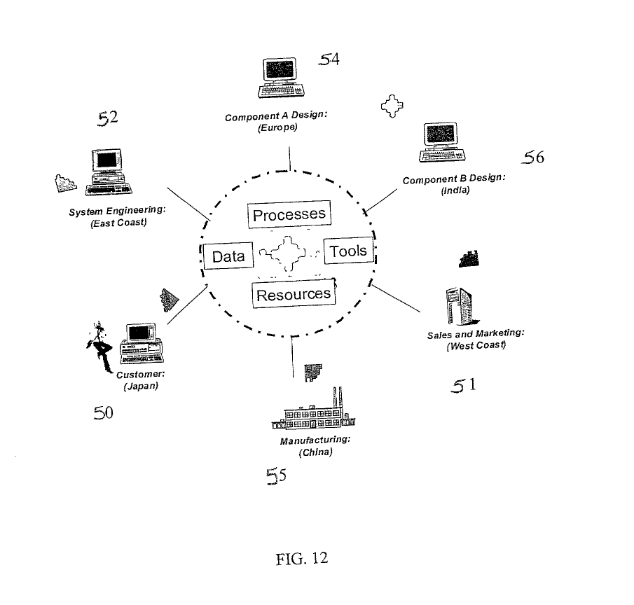

FIG. 12 illustrates an exemplary embodiment of exchange of design information in an engineering organization utilizing a central repository and knowledge warehouse. Customer 50, sales and marketing 51, system engineering 52, component designers 54 and 56, and manufacturing 55 exchange design information via a design collaboration environment including an Internet-based central repository and knowledge warehouse. All participating locations/sub-organizations may view and interact with the central repository and knowledge warehouse via the Internet in a secure manner. Moreover, what each location/sub-organization or even individual views may be customized by the central repository based on:

1. Spatial parameters: regional location of the individual, for example, data or tasks served in the spoken language.

2. Temporal parameters: the current tasks or assignments given to the individual or to the larger entity (location or sub-organization). For example, certain tools are provided automatically to the engineer to aid in performing certain tasks. The tools are different from one task to the other.

3. Background parameters: Information, customized tools and processes may be served to different individuals based on their educational background or security clearances.

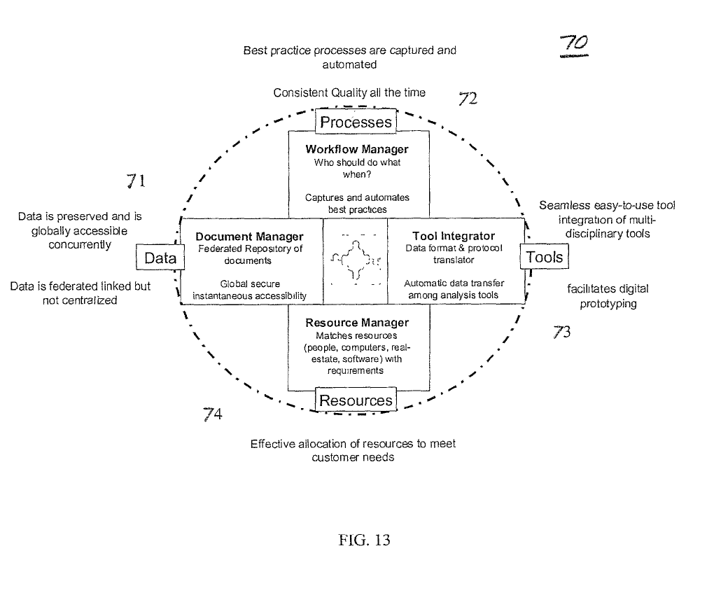

FIG. 13 illustrates an exemplary embodiment of a central repository 70 that may be included in the embodiment of FIG. 12. Note that the central repository 70 may include a document manager (or data manager) 71 in which data (embodied in documents) may be preserved under revision control. The document manager 71 may provide global secure and concurrent access to documents (comprising data) via the Internet. Thus, individuals may gain access to relevant data only. Concurrency access may be provided to several individuals, wherein each may gain access to the same document (while the document manager 71 avoids clashes and resolves any concurrency issues based on the best processes prescribed by a workflow manager 72 as discussed below).

The workflow manager 72 may capture utilized processes (coupled with the knowledge warehouse) to ensure that the best available processes are being used, thus, ensuring consistent quality across the locations and sub-organizations. One process that may be captured and embodied by the workflow manager is the DFSS. The tool integrator 73 is a repository of the available tools, which are seamlessly integrated with each other. The tool integrator 73 serves in automatic translation (or data/protocol transfer) between one tool and the other, resulting in the integration of multi-disciplinary tools (across sub-organizational boundaries). The tool integrator 71 enables digital mock-up of the entire product, rather than just its components. The resource manager 74 is a repository of the available resources (human, real-estate, hardware, software, and the like) and utilizes an “optimizer” for aiding decision makers to best match resources with requirements.

Note that the term “central” in central repository 70 does not imply that the digitized data, processes, tools, and resources reside in a central or even single computer. The central repository 70 may include a directory having pointers to data, processes, tools, and resources residing on many computers (or equivalent equipment) at any location. Thus, users may interact with a constellation of computers via the central repository 70 as if all data, tools, resources, and processes resided on one central computer. This allows for an integration or “federation” of the locations/sub-organizations.

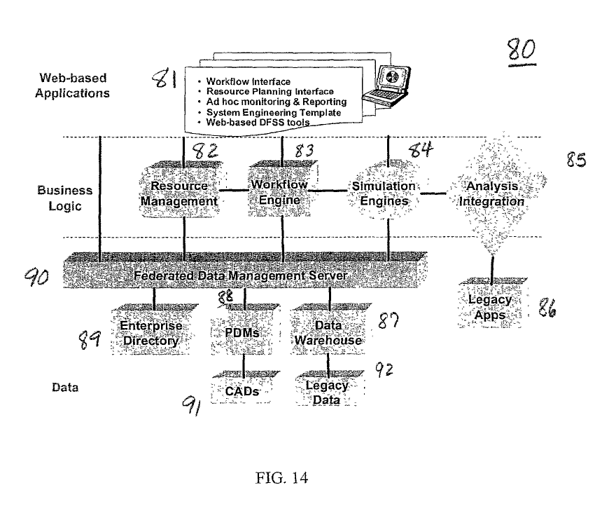

FIG. 14 is an exemplary embodiment of an architecture 80 for implementing the central repository 70. The architecture 80 may include an enterprise directory 89, which is a searchable list of the available resources in the company. Data sets within the enterprise directory 89 may be viewed as documents, which may be integrated together via a federated data management server 90 (described below). The enterprise directory 89, coupled with a resource management 82 system, embodies the resource manager 74 tool previously described. CADs 91 systems are typically significant data sets that may be an entity of their own. Many PDMs 88 systems may be used to manage drawings within a hierarchical product structure. PDMs 88 systems are commercially available and are referred to as CAD-based PDMs. Further, PDMs 88 may be a layer of abstraction on top of CADs 91. However, other PDMs may have a larger scope and may be utilized for managing data of any type, thus, the embodiment is not limited to CAD systems. Such PDMs are referred to as ePDMs, and when coupled with workflow tools may be utilized for the federated data management server 90 and a workflow engine 83 (described below). Data warehouse 87 is a repository of data from ongoing and past projects, which seamlessly integrates legacy data 92 residing in legacy systems. Therefore, the data warehouse 87 may be viewed as an abstraction layer for the legacy data 92, in addition to its original purpose of storing data.

The federated data management server 90 is a tool for providing seamless access to the data in the organization, including data from an enterprise directory 89, the PDMs 88 and/or the data warehouse 87. The federated data management server 90 may be an embodiment utilized in the document manager 71. Resource management 82 is a tool having access to the enterprise directory 89 (either directly or via the federated data management server 90). Resource management 82 assists in optimally allocating resources to match requirements (as demanded by the workflow engine 83). The workflow engine 83 captures and enforces the best available processes in the company. Simulation engines 84 are tools utilized by engineers to estimate product performance requirements. Multi-disciplinary simulation engines may be integrated together, and with legacy applications 86, via an analysis integration 85 tool. Analysis integration 85 may be an embodiment utilized in the tool integrator 73, and may be viewed as an abstraction layer on top of both legacy applications 86 and simulation engines 84.

An embodiment having a three-tier architecture environment may include a first tier having the enterprise directory 89, CADs 91, PDMs 88, data warehouse 87 and legacy data 92, which include forms of data that is federated and managed by the federated data management server 90. The second tier may include the resource management 82, workflow engine 83, simulation engines 84, analysis integration 85 and legacy applications 86. These are elements of business logic and may include tools and processes in addition to logic of resource allocations. The third tier may include a user interface 81. Thus, the first and second tiers may be Internet accessible via various tools available to engineers (such as web browsers or other clients).

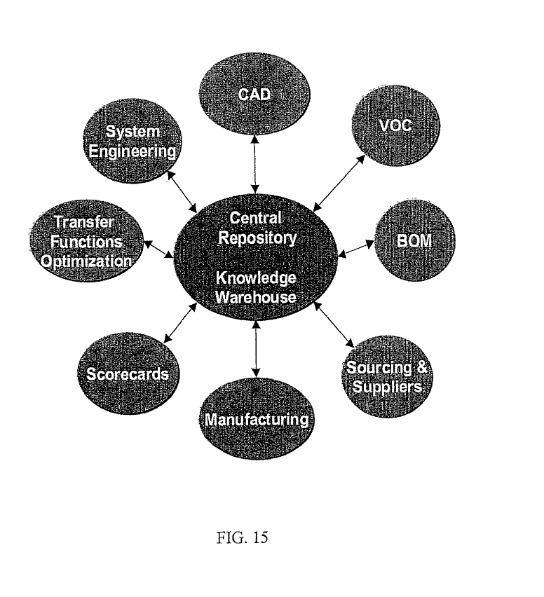

Thus, the embodiments described shift the complex web of communicating design information from that illustrated in FIG. 11 into that illustrated in FIG. 15, in which tools are integrated together and are seamlessly accessible via a network, such as the Internet. Moreover, data input/output from the various tools may be maintained in a central repository and knowledge warehouse, which includes the processes and resources available to invoke the appropriate tools. The tools illustrated in FIG. 15 may have Web-based interfaces. For example, Web-based scorecards (e-scorecards) for monitoring the design process and the current quality of the designed product may be included. Similarly, Web-based interfaces may be developed for the other tools, in accordance with the architecture previously described.

Therefore, the various embodiments provide a “backbone” for an effective, reliable and cheaper design process, which is lacking most engineering organizations. Moreover, the major disadvantages of the existing process are eliminated. Instead, each engineer may submit information, which is immediately communicated to all affected and/or interested parties. A standardized process allows the engineers to efficiently and productively perform a design task. Plus, engineers are given the freedom from having to learn about the organization structure, or even the overall product. In other words, a design network enables them to perform their tasks (activities) and filter the conclusions of those activities across the organization. As mentioned a comprehensive help system may also be included. An advantage of such a help system, is that it can capture accumulated engineering knowledge via a searchable database of previous projects. Further, engineers do not have to memorize the names of individuals affected by their activities. In fact, engineers can be separated on different continents, in different organizations, and still communicate the design events effectively.

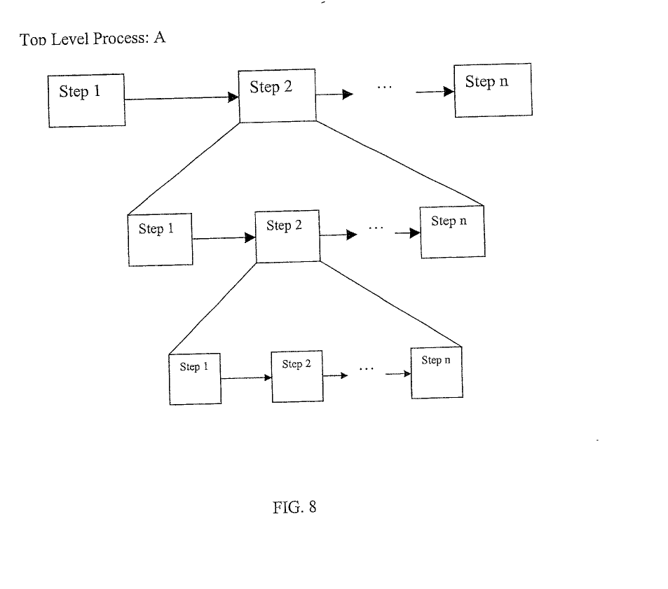

Another embodiment may include a multi-tier client/server object-oriented architecture. This may be accomplished by implementing different layers of processes, each process being determined by different individuals (process owners) at different stages of the design process. In FIG. 8, the top level (overall) process is denoted as A. Each step of that process can itself be a process, e.g., Step 1, Step 2 . . . Step n. Thus, the chain of processes can go indefinitely, if needed. Each step of the top level process may have one or more levels (sub levels), which may have one or more steps. In turn each sub level may have sub-sub levels associated therewith. Such an architecture facilitates a design process by laying out the overall design process from the beginning. Steps of that overall design process are assigned to individual owners (or organizations). The owner of each step will lay out the process (sub-process) needed to accomplish the step, and again assign tasks and owners to each of the steps of the sub-process, and so on. Therefore, engineers and/or sub-organizations are empowered with the ability to design and control their own processes as long as they deliver the necessary outcome required at the end of the process they own. Consequently, the corresponding Web-based program may be object-oriented to support multiple instantiating of the process class. Also, late binding may be supported, such as, the ability to design sub-processes during the program execution. Further, recycling of previously developed processes may be supported (so that users can recycle older process and plug-in for use in a new project).

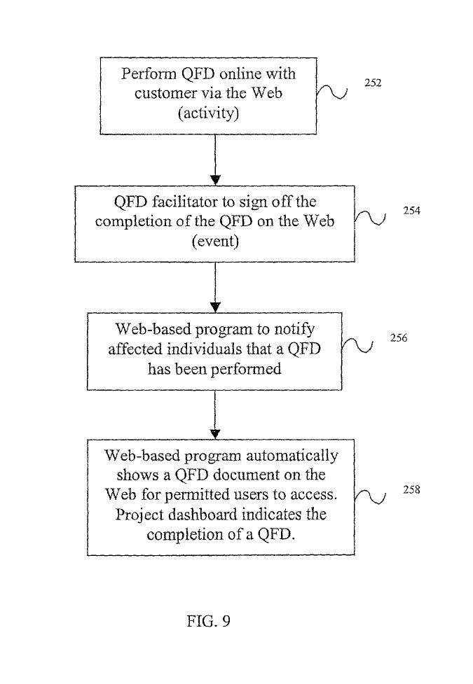

For example, to implement the DFSS process of FIG. 2 within such an architecture, there is only a need at the beginning to lay out the overall process with each block shown in FIG. 2 being a step of the process. Noting that step 102 in FIG. 2 is to identify customer product requirements, the task may be assigned to an individual or a sub-organization, which will layout the quality function deployment (QFD) process to be performed (or recycle the same process used previously in a similar project). QFD is a system for translating consumer requirements into appropriate company requirements at each stage from research/product development, to engineering and manufacturing, to marketing/sales and distribution. QFD may be an automated process as shown in the flow chart of FIG. 9. In step 252, of FIG. 9, QFD is performed online with the customer via the Web (activity). In step 254, the QDF facilitator signs off the completion of the QFD on the Web (event). In step 256, a Web-based program notifies affected individuals that a QFD has been performed. In step 258, the Web-based program automatically shows a QFD document on the Web for permitted users to access, and a project dashboard indicates the completion of a QFD.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for performing engineering design, the system comprising:
a client for receiving first design information from a first source;
a server coupled to said client via a network, said client uploading said first design information to said server;
said server determining whether said first source has authorization to submit said first design information, notifying a second source of said first design information and transmitting said first design information to said second source;
said server storing said design information.

2. The system of claim 1, wherein:
said receiving said first design information includes said server receiving said first design information via a network;
said notifying said second source includes said server notifying said second source via said network; and
said transmitting said first design information includes said server transmitting said first design information via said network.

3. The system of claim 2, wherein said network is the Internet.

4. The system of claim 1, further including said server:
notifying a next source of said first design information; and
transmitting said first design information to said next source.

5. The system of claim 4, further including said server:
receiving next design information from said next source;
determining whether said next source has authorization to submit said next design information;
determining whether to notify said first source of said next design information;
notifying said first source of said next design information; and
transmitting said next design information to said first source.

6. The system of claim 1, further including said server:
receiving second design information from said second source;
determining whether said second source has authorization to submit said second design information;
notifying said first source of said second design information; and
transmitting said second design information to said first source.

7. The system of claim 6, further including said server:
notifying a next source of said second design information; and
transmitting said second design information to said next source.

8. The system of claim 7, further including said server:
notifying said next source of said first design information; and
transmitting said first design information to said next source.

9. The system of claim 7, further including said server:
receiving next design information from said next source;
determining whether said next source has authorization to submit said next design information;
notifying said second source of said next design information; and
transmitting said next design information to said second source.

10. The system of claim 7, further including said server:
receiving next design information from said next source;
determining whether said next source has authorization to submit said next design information;
notifying said first source of said next design information; and
transmitting said next design information to said first source.

11. A system for performing engineering design using the Internet, the system comprising:
a client for receiving first design information from a first source;
a server coupled to said client via a network, said client uploading said first design information to said server;
said server determining whether said first source has authorization to submit said first design information, storing said first design information based on said determining whether said first source has authorization, determining whether to notify a second source of said first design information, determining whether said second source has authorization to receive said first design information, notifying said second source of said first design information based on said determining whether to notify said second source, receiving a request from said second source for said first design information and transmitting said first design information to said second source; and
said server storing said design information.

12. The system of claim 11, further including said server:
determining whether to notify a next source of said first design information;
notifying said next source of said first design information based on said determining whether to notify said next source;
receiving a request from said next source for said first design information; and
transmitting said first design information to said next source.

13. The system of claim 12, further including said server:
receiving next design information from said next source;
determining whether said next source has authorization to submit said next design information;
storing said next design information based on said determining whether said next source has authorization;
determining whether to notify said first source of said next design information;
determining whether said first source has authorization to receive said next design information;
notifying said first source of said next design information based on said determining whether to notify said first source;
receiving a request from said first source for said next design information; and
transmitting said next design information to said first source.

14. The system of claim 11, further including said server:
receiving second design information from said second source;
determining whether said second source has authorization to submit said second design information;
storing said second design information based on said determining whether said second source has authorization to submit said second design information;
determining whether to notify said first source of said second design information;
determining whether said first source has authorization to receive said second design information;
notifying said first source of said second design information based on said determining whether to notify said first source;
receiving a request from said first source for said second design information; and
transmitting said second design information to said first source.

15. The system of claim 14, further including said server:
determining whether to notify a next source of said second design information;
notifying said next source of said second design information based on said determining whether to notify said next source;
receiving a request from said next source for said second design information; and
transmitting said second design information to said next source.

16. The system of claim 15, further including said server:
determining whether to notify said next source of said first design information;
notifying said next source of said first design information based on said determining whether to notify said next source;
receiving a request from said next source for said first design information; and
transmitting said first design information to said next source.

17. The system of claim 15, further including said server:
receiving next design information from said next source;
determining whether said next source has authorization to submit said next design information;
storing said next design information based on said determining whether said next source has authorization;
determining whether to notify said second source of said next design information;
determining whether said second source has authorization to receive said next design information;
notifying said second source of said next design information based on said determining whether to notify said second source;
receiving a request from said second source for said next design information; and
transmitting said next design information to said second source.

18. The system of claim 15, further including said server:
receiving next design information from said next source;
determining whether said next source has authorization to submit said next design information;
storing said next design information based on said determining whether said next source has authorization;
determining whether to notify said first source of said next design information;
determining whether said first source has authorization to receive said next design information;
notifying said first source of said next design information based on said determining whether to notify said first source;
receiving a request from said first source for said next design information; and
transmitting said next design information to said first source.

19. System for performing engineering design using a network, the system comprising:
an network accessible backbone for enabling collaborative engineering design;
wherein said backbone includes a central repository and a knowledge warehouse.

20. The system of claim 19, wherein said network is the Internet.

21. The system of claim 19, wherein said central repository includes digitization tools, processes, resources and data.

22. The system of claim 19, wherein said central repository includes:
a data manager;
a workflow manager for managing processes;
a resource allocation tool for managing resources; and
a tools integrator for managing tools.

23. The system of claim 22, wherein said data manager includes a computer program for integrating data from heterogeneous sources.

24. The system of claim 22, wherein said data manager includes a central repository for data in an organization.

25. The system of claim 22, wherein said data manager includes pointers to data residing on a computer.

26. The system of claim 22, wherein said workflow manager includes a computer program for executing and enforcing programmed processes.

27. The system of claim 22, wherein said resource allocation tool includes a computer program for optimizing resource allocation in an organization.

28. The system of claim 22, wherein said tool integrator includes a computer program for integrating heterogeneous tools.

29. The system of claim 19, wherein said knowledge warehouse includes data, processes, tools, and resource allocation patterns identified as best practice.

30. The system of claim 22, further including a product data management system.

31. A system for performing engineering design, the system comprising:
client means for receiving first design information from a first source;
server means for determining whether said first source has authorization to submit said first design information, notifying a second source of said first design information and transmitting said first design information to said second source;
said server means storing said design information.

32. A system for performing engineering design using the Internet, the system comprising:
client means for receiving first design information from a first source;
server means for determining whether said first source has authorization to submit said first design information, storing said first design information based on said determining whether said first source has authorization, determining whether to notify a second source of said first design information, determining whether said second source has authorization to receive said first design information, notifying said second source of said first design information based on said determining whether to notify said second source, receiving a request from said second source for said first design information and transmitting said first design information to said second source; and
said server means storing said design information.

33. A system for performing engineering design using a network, the system comprising:
means for a network accessible backbone for enabling collaborative engineering design; and
wherein said means for a network accessible backbone includes a central repository and a knowledge warehouse.

34. A method for performing engineering design, the method comprising:
receiving first design information from a first source;
determining whether said first source has authorization to submit said first design information;
notifying a second source of said first design information; and
transmitting said first design information to said second source.

35. The method of claim 34, wherein:
said receiving said first design information includes receiving said first design information via a network;
said notifying said second source includes notifying said second source via said network; and
said transmitting said first design information includes transmitting said first design information via said network.

36. The method of claim 35, wherein said network is the Internet.

37. The method of claim 34, further including:
notifying a next source of said first design information; and
transmitting said first design information to said next source.

38. The method of claim 37, further including:
receiving next design information from said next source;
determining whether said next source has authorization to submit said next design information;
determining whether to notify said first source of said next design information;
notifying said first source of said next design information; and
transmitting said next design information to said first source.

39. The method of claim 34, further including:
receiving second design information from said second source;
determining whether said second source has authorization to submit said second design information;
notifying said first source of said second design information; and
transmitting said second design information to said first source.

40. The method of claim 39, further including:
notifying a next source of said second design information; and
transmitting said second design information to said next source.

41. The method of claim 40, further including:
notifying said next source of said first design information; and
transmitting said first design information to said next source.

42. The method of claim 40, further including:
receiving next design information from said next source;
determining whether said next source has authorization to submit said next design information;
notifying said second source of said next design information; and
transmitting said next design information to said second source.

43. The method of claim 40, further including:
receiving next design information from said next source;
determining whether said next source has authorization to submit said next design information;
notifying said first source of said next design information; and
transmitting said next design information to said first source.

44. A method for performing engineering design using the Internet, the method comprising:
receiving first design information from a first source;
determining whether said first source has authorization to submit said first design information;
storing said first design information based on said determining whether said first source has authorization;
determining whether to notify a second source of said first design information;
determining whether said second source has authorization to receive said first design information;
notifying said second source of said first design information based on said determining whether to notify said second source;
receiving a request from said second source for said first design information; and
transmitting said first design information to said second source.

45. The method of claim 44, further including:
determining whether to notify a next source of said first design information;
notifying said next source of said first design information based on said determining whether to notify said next source;
receiving a request from said next source for said first design information; and
transmitting said first design information to said next source.

46. The method of claim 45, further including:
receiving next design information from said next source;
determining whether said next source has authorization to submit said next design information;
storing said next design information based on said determining whether said next source has authorization;
determining whether to notify said first source of said next design information;
determining whether said first source has authorization to receive said next design information;
notifying said first source of said next design information based on said determining whether to notify said first source;
receiving a request from said first source for said next design information; and
transmitting said next design information to said first source.

47. The method of claim 44, further including:
receiving second design information from said second source;
determining whether said second source has authorization to submit said second design information;
storing said second design information based on said determining whether said second source has authorization to submit said second design information;
determining whether to notify said first source of said second design information;
determining whether said first source has authorization to receive said second design information;
notifying said first source of said second design information based on said determining whether to notify said first source;
receiving a request from said first source for said second design information; and
transmitting said second design information to said first source.

48. The method of claim 47, further including:
determining whether to notify a next source of said second design information;
notifying said next source of said second design information based on said determining whether to notify said next source;
receiving a request from said next source for said second design information; and
transmitting said second design information to said next source.

49. The method of claim 48, further including:
determining whether to notify said next source of said first design information;
notifying said next source of said first design information based on said determining whether to notify said next source;
receiving a request from said next source for said first design information; and
transmitting said first design information to said next source.

50. The method of claim 48, further including:
receiving next design information from said next source;
determining whether said next source has authorization to submit said next design information;
storing said next design information based on said determining whether said next source has authorization;
determining whether to notify said second source of said next design information;
determining whether said second source has authorization to receive said next design information;
notifying said second source of said next design information based on said determining whether to notify said second source;
receiving a request from said second source for said next design information; and
transmitting said next design information to said second source.

51. The method of claim 48, further including:
receiving next design information from said next source;
determining whether said next source has authorization to submit said next design information;
storing said next design information based on said determining whether said next source has authorization;
determining whether to notify said first source of said next design information;
determining whether said first source has authorization to receive said next design information;
notifying said first source of said next design information based on said determining whether to notify said first source;
receiving a request from said first source for said next design information; and
transmitting said next design information to said first source.

52. A method for performing engineering design using a network accessible backbone, a central repository having a data manager, workflow manager, resource allocation tool and tools integrator, and a knowledge warehouse, the method comprising:
said central repository maintaining an instance of each ongoing project in an organization; and
said data manager maintaining pointers to data residing on a computer and presenting said pointers if said data resides on said data manager's computer.

53. The method of claim 52, wherein said network is the Internet.

54. The method of claim 52, further including said data manager integrating data from legacy systems.

55. The method of claim 52, further including said data manager integrating data managed by computer aided design systems.

56. The method of claim 52, further including said data manager integrating data managed by product data management systems.

57. The method of claim 52, further including said workflow manager executing and enforcing a design for six sigma process.

58. The method of claim 52, further including said resource allocation tool accessing a directory of resources.

59. The method of claim 52, further including said tool integrator estimating the performance of a product under operating conditions.

60. The method of claim 52, further including said tool integrator executing simulation and legacy tools.

61. The method of claim 52, further including identifying data, processes, tools and resource allocation patterns as best practice.

62. The method of claim 52, further including restricting access to said network based a security constraint.

63. The method of claim 52, further including monitoring the progress of a product's quality during and after the design process.

64. A storage medium encoded with machine-readable computer program code for performing engineering design, said storage medium including instructions for causing a processor to implement a method comprising:
receiving first design information from a first source;
determining whether said first source has authorization to submit said first design information;
notifying a second source of said first design information; and
transmitting said first design information to said second source.

65. A storage medium encoded with machine-readable computer program code for performing engineering design using the Internet, said storage medium including instructions for causing a processor to implement a method comprising:
receiving first design information from a first source;
determining whether said first source has authorization to submit said first design information;
storing said first design information based on said determining whether said first source has authorization;
determining whether to notify a second source of said first design information;
determining whether said second source has authorization to receive said first design information;
notifying said second source of said first design information based on said determining whether to notify said second source;
receiving a request from said second source for said first design information; and
transmitting said first design information to said second source.

66. A computer data signal for performing engineering design, said computer data signal comprising code conFIG. to cause a processor to implement a method comprising:
receiving first design information from a first source;
determining whether said first source has authorization to submit said first design information;
notifying a second source of said first design information; and
transmitting said first design information to said second source.

67. The computer data signal of claim 66, wherein said computer data signal is embodied in a carrier wave.

68. The computer data signal of claim 66 wherein said computer data signal is unmodulated.

69. A computer data signal for performing engineering design using the Internet, said computer data signal including code conFIG.d to cause a processor to implement a method comprising:
receiving first design information from a first source;
determining whether said first source has authorization to submit said first design information;
storing said first design information based on said determining whether said first source has authorization;
determining whether to notify a second source of said first design information;
determining whether said second source has authorization to receive said first design information;
notifying said second source of said first design information based on said determining whether to notify said second source;
receiving a request from said second source for said first design information; and
transmitting said first design information to said second source.
